(19) United States
(12) Patent Application Publication
(10) Pub. No.: US 2008/0059200 A1
(43) Pub. Date: Mar. 6, 2008

(54) Multi-Lingual Telephonic Service

(75) Inventor: Mayurnath Puli, Bangalore (IN)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture Global Services GMBH, Schaffhausen (CH)

(21) Appl. No.: 11/552,309

(22) Filed: Oct. 24, 2006

(30) Foreign Application Priority Data
Aug. 22, 2006 (IN) 1319/MUM/2006

(51) Int. Cl. G10L 21/00

(52) U.S. Cl. 704/277

(57) ABSTRACT

Methods and apparatuses for translating speech from one language to another language during telephonic communications. Speech is converted from a first language to a second language as a user speaks with another user. If the translation operation is symmetric, speech is converted from the second language to the first language in the opposite communications direction. A received speech signal is processed to determine a symbolic representation containing phonetic symbols of the source language and to insert prosodic symbols into the symbolic representation. A translator translates a digital audio stream into a translated speech signal in the target language. Furthermore, a language-independent speaker parameter may be identified so that the characteristic of the speaker parameter is preserved with the translated speech signal. Regional characteristics of the speaker may be utilized so that colloquialisms may be converted to standardized expressions of the source language before translation.

### FIELD OF THE INVENTION

This invention relates generally to multi-lingual services for telephonic systems. More particularly, the invention provides apparatuses and methods for translating speech from one language to another language during a communications session.

### BACKGROUND OF THE INVENTION

Wireless communications has brought a revolution in the communication sector. Today mobile (cellular) phones are playing a vital role in every human's life, where a mobile phone is not just a communication device, but is also a utilitarian device which facilitates the daily life of a user. Innovative ideas have resulted in mobile terminals having enhanced usability for the user. A mobile phone is not only used for voice, data, and image communication but also functions as PDA, scheduler, camera, video player, and walkman.

With the many innovations in mobile telephones, corporations are often conducting business across countries throughout the world. As an example, a furniture manufacturer may have headquarters located in India; however, important customers may be located in China, Japan, and France. To be competitive in its foreign markets, an executive of the furniture typically must be able to communicate effectively with a foreign customer. To expand on the example, the executive of the furniture manufacturer may be fluent only in Hindi but may wish to talk in Japanese with a customer in Japan, or in French with a different customer in France, or in English with another customer in the United States. Speaking in the customer's native language can help the Indian manufacturer in enhancing profitability.

A translation mechanism was fictionalized as a Babel fish in the science fiction classic The Hitchhiker's Guide to the Galaxy by Douglas Adams. With a fictionalized Babel fish, one could stick the Babel fish in one's ear and instantly understand anything said in any language. As with a Babel fish, the above exemplary scenario illustrates the benefit of a translation service that can translate speech in one language to speech in another language for users communicating through telephonic devices.

### BRIEF SUMMARY OF THE INVENTION

Embodiments of invention provide methods and systems for translating speech for telephonic communications. Among other advantages, the disclosed methods and apparatuses facilitate communications between users who are not fluent in a common language.

With one aspect of the invention, speech is converted from a first language to a second language as a user talks with another user. If the translation operation is symmetric, speech is converted from the second language to the first language in the opposite communications direction.

With another aspect of the invention, a user of a wireless device requests that the speech during a call be translated. The translation service may support speech over the uplink radio channel and/or over the downlink radio channel. The translation service is robust and continues during a handover from one base transceiver station to another base station transceiver station.

With another aspect of the invention, a received speech signal is processed to determine a symbolic representation containing phonetic symbols of the source language and to insert prosodic symbols into the symbolic representation.

With another aspect of the invention, a speaker parameter that is language independent is identified. A received speech signal is processed so that the characteristic of the speaker parameter is preserved with the translated speech signal.

With another aspect of the invention, a user may configure the translation service in accordance with configurations that may include the source language and the target language. In addition, a regional identification of the speaker may be included so that colloquialisms may be converted to standardized expression of the source language.

With another aspect of the invention, a received speech signal is analyzed to determine if the content corresponds to the configured source language. If not, the translation service disables translation so that the translation service is transparent to the received speech signal.

With another aspect of the invention, a server translates speech signal during a communications session. A speech recognizer converts the speech signal into a symbolic representation containing a plurality of phonetic symbols. A text-to-speech synthesizer inserts a plurality of prosodic symbols within the symbolic representation in order to include the pitch and emotional aspects of the speech being articulated by the user and synthesizes a digital audio stream from the symbolic representation. A translator subsequently generates a translated speech signal in the second language.

### BRIEF DESCRIPTION OF THE DRAWINGS

The present invention is illustrated by way of example and not limited in the accompanying figures in which like reference numerals indicate similar elements and in which:

FIG. 1 shows an architecture of a computer system used in a multi-lingual telephonic service in accordance with an embodiment of the invention.

FIG. 2 shows a wireless system supports a multi-lingual telephonic service in accordance with an embodiment of the invention.

FIG. 3 shows a wireless system supporting a multi-lingual telephonic service during a handover in accordance with an embodiment of the invention.

FIG. 4 shows a flow diagram for a multi-lingual telephonic service in accordance with an embodiment of the invention.

FIG. 5 shows messaging between different entities of a wireless system in accordance with an embodiment of the invention.

FIG. 6 shows an architecture of a call center that supports a multi-lingual telephonic service in accordance with an embodiment of the invention.

FIG. 7 shows an exemplary display for configuring a translation service in accordance with an embodiment of the invention.

FIG. 8 shows an architecture of a Automatic Speech Recognition/Text to Speech Synthesis/Speech Translation (ATS) server in accordance with an embodiment of the invention.

### DETAILED DESCRIPTION OF THE INVENTION

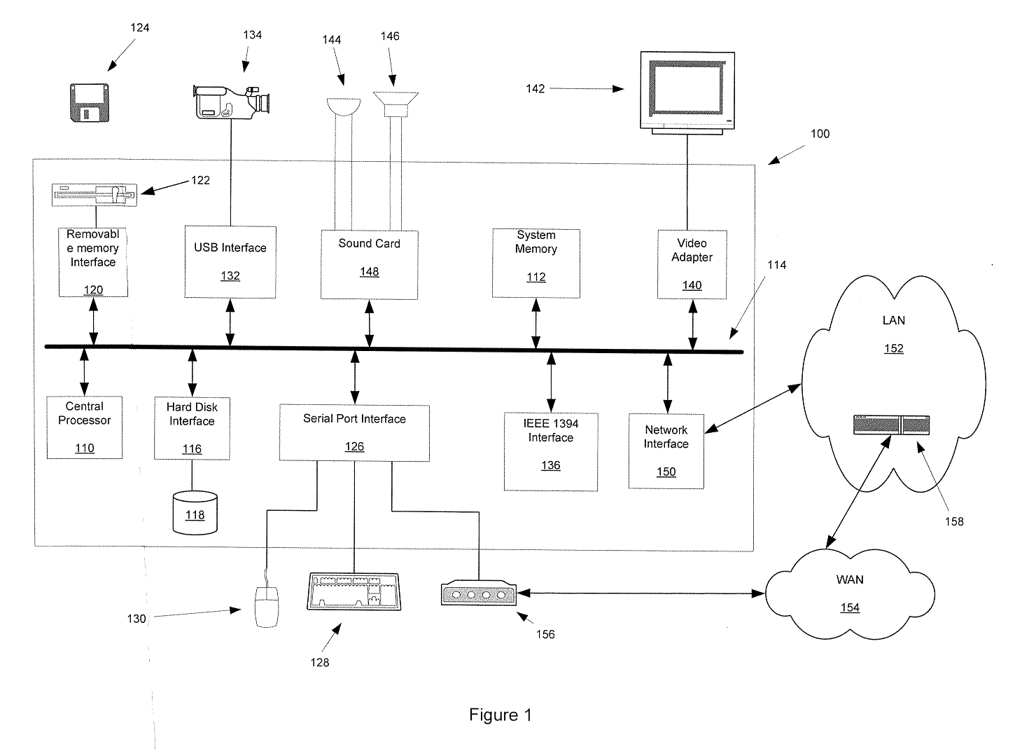

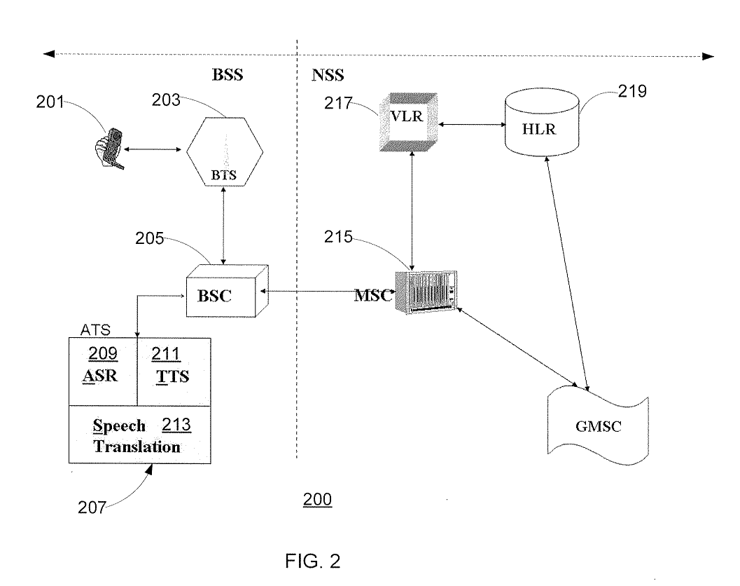

Elements of the present invention may be implemented with computer systems, such as the system 100 shown in FIG. 1. Computer 100 may be incorporated in different entities of a wireless system that supports a multi-lingual telephonic service as shown in FIG. 2. As will be further discussed, computer 100 may provide the functionality of server 207, which includes automatic speech recognition, text to speech synthesis, and speech translation. Computer 100 includes a central processor 110, a system memory 112 and a system bus 114 that couples various system components including the system memory 112 to the central processor unit 110. System bus 114 may be any of several types of bus structures including a memory bus or memory controller, a peripheral bus, and a local bus using any of a variety of bus architectures. The structure of system memory 112 is well known to those skilled in the art and may include a basic input/output system (BIOS) stored in a read only memory (ROM) and one or more program modules such as operating systems, application programs and program data stored in random access memory (RAM).

Computer 100 may also include a variety of interface units and drives for reading and writing data. In particular, computer 100 includes a hard disk interface 116 and a removable memory interface 120 respectively coupling a hard disk drive 118 and a removable memory drive 122 to system bus 114. Examples of removable memory drives include magnetic disk drives and optical disk drives. The drives and their associated computer-readable media, such as a floppy disk 124 provide nonvolatile storage of computer readable instructions, data structures, program modules and other data for computer 100. A single hard disk drive 118 and a single removable memory drive 122 are shown for illustration purposes only and with the understanding that computer 100 may include several of such drives. Furthermore, computer 100 may include drives for interfacing with other types of computer readable media.

A user can interact with computer 100 with a variety of input devices. FIG. 1 shows a serial port interface 126 coupling a keyboard 128 and a pointing device 130 to system bus 114. Pointing device 128 may be implemented with a mouse, track ball, pen device, or similar device. Of course one or more other input devices (not shown) such as a joystick, game pad, satellite dish, scanner, touch sensitive screen or the like may be connected to computer 100.

Computer 100 may include additional interfaces for connecting devices to system bus 114. FIG. 1 shows a universal serial bus (USSB) interface 132 coupling a video or digital camera 134 to system bus 114. An IEEE 1394 interface 136 may be used to couple additional devices to computer 100. Furthermore, interface 136 may configured to operate with particular manufacture interfaces such as FireWire developed by Apple Computer and i.Link developed by Sony. Input devices may also be coupled to system bus 114 through a parallel port, a game port, a PCI board or any other interface used to couple and input device to a computer.

Computer 100 also includes a video adapter 140 coupling a display device 142 to system bus 114. Display device 142 may include a cathode ray tube (CRT), liquid crystal display (LCD), field emission display (FED), plasma display or any other device that produces an image that is viewable by the user. Additional output devices, such as a printing device (not shown), may be connected to computer 100.

Sound can be recorded and reproduced with a microphone 144 and a speaker 166. A sound card 148 may be used to couple microphone 144 and speaker 146 to system bus 114. One skilled in the art will appreciate that the device connections shown in FIG. 1 are for illustration purposes only and that several of the peripheral devices could be coupled to system bus 114 via alternative interfaces. For example, video camera 134 could be connected to IEEE 1394 interface 136 and pointing device 130 could be connected to USB interface 132.

Computer 100 can operate in a networked environment using logical connections to one or more remote computers or other devices, such as a server, a router, a network personal computer, a peer device or other common network node, a wireless telephone or wireless personal digital assistant. Computer 100 includes a network interface 150 that couples system bus 114 to a local area network (LAN) 152. Networking environments are commonplace in offices, enterprise-wide computer networks and home computer systems.

A wide area network (WAN) 154, such as the Internet, can also be accessed by computer 100. FIG. 1 shows a modem unit 156 connected to serial port interface 126 and to WAN 154. Modem unit 156 may be located within or external to computer 100 and may be any type of conventional modem such as a cable modem or a satellite modem. LAN 152 may also be used to connect to WAN 154. FIG. 1 shows a router 158 that may connect LAN 152 to WAN 154 in a conventional manner.

It will be appreciated that the network connections shown are exemplary and other ways of establishing a communications link between the computers can be used. The existence of any of various well-known protocols, such as TCP/IP, Frame Relay, Ethernet, FTP, HTTP and the like, is presumed, and computer 100 can be operated in a client-server configuration to permit a user to retrieve web pages from a web-based server. Furthermore, any of various conventional web browsers can be used to display and manipulate data on web pages.

The operation of computer 100 can be controlled by a variety of different program modules. Examples of program modules are routines, programs, objects, components, data structures, etc., that perform particular tasks or implement particular abstract data types. The present invention may also be practiced with other computer system configurations, including hand-held devices, multiprocessor systems, microprocessor-based or programmable consumer electronics, network PCS, minicomputers, mainframe computers, personal digital assistants and the like. Furthermore, the invention may also be practiced in distributed computing environments where tasks are performed by remote processing devices that are linked through a communications network. In a distributed computing environment, program modules may be located in both local and remote memory storage devices.

FIG. 2 shows a wireless system 200 supports a multi-lingual telephonic service in accordance with an embodiment of the invention. With the architecture shown in FIG. 2, additional software or hardware is not required on NSS network side system (NSS) in order to support the multi-lingual telephonic service. As will be discussed, additional hardware and software are incorporated on the base station subsystem (BSS).

By wireless system 200 providing translation functionality, a person who speaks only French can speak in Japanese with another person who speaks only Japanese without knowing the semantics of the Japanese language. Conversely, the person who speaks Japanese can speak in French to the person who knows French.

The following sequential steps exemplify the process of the multi lingual communication service over wireless device 201:
1) User pushes a button in the wireless device 201.
2) An exemplary list of language translation options is displayed on wireless device 201:
   a. English to French
   b. English to Japanese
   c. Spanish to English (with a British accent)
   d. Spanish to English (with an American accent)
   e. Chinese to Hindi
Typically, translation is a symmetric operation. In other words, speech from one user is translated from a first language to a second language while speech from the other user is translated from the second language to the first language. However, there are situations where the translation process is not symmetric. For example, one of the users may be fluent in both languages so that that translation from one language to the other language is not required.
3) User selects one option (e.g., English to Japanese).
4) Wireless device 201 informs the Base Station (BSC) 205 through Base Transceiver Station (BTS) 203 that the call needs a special treatment (i.e., translation service). Wireless device 201 transmits to BTS 203 over an uplink wireless channel and receives from BTS 203 over a downlink wireless channel.
5) BSC 205 conveys the Mobile Switching Center (MSC) 215 and receives a confirmation whether the user has a privilege for this special call.
6) MSC 215 queries the VLR/HLR 217,219 and sends a confirmation to BSC 205.
7) If the user has privileges, BSC 205 routes the communication to Automatic Speech Recognition/Text to Speech Synthesis/Speech Translation (ATS) server 207. Consequently, an interface is supported between BSC 205 and ATS server 207.
8) Automatic Speech Recognition (ASR) component 209 of ATS server 207 converts the English speech to English Text with the grammar intact.
9) Speech Translation component 213 of ATS server 207 converts the English Text to Japanese with the grammar and human frequencies intact.
10) Text to Speech Synthesis (TTS) component 211 of ATS server 207 synthesizes the Japanese text to Japanese speech and ultimately to a byte stream.

11) The byte stream is sent to BSC 205 and the remainder of the call path is configured as any other call.

In order to reduce the work performed by ATS server 207, wireless device 201 may perform a portion of speech recognition and speech synthesis. For example, wireless device 201 may digitize speech and breakdown digitalized speech to basic vowel/consonant sounds (often referred as phonemes). Phonemes are distinctive speech sounds of a particular language. Phonemes are then combined to form syllables, which then form words of the language. Mobile device 201 may also playback the synthesized speech. (In embodiments of the invention, ATS server 207 may perform the above functionality.) ATS server 207 performs the remainder of the speech processing functionality, including automatic speech recognition ASR (corresponding to component 209), text-to-speech synthesis TTS (corresponding to component 211), and speech translation (corresponding to component 213). A multilingual call set up involves the above three processes, which may be considered to be overhead when compared with a normal call set up. ATS server 207 adopts efficient algorithms to resolve grammar and human/machine accent related issues.

Automatic speech recognition component 209 may utilize statistical modeling or matching. With statistical modeling, the speech is matched to phonetic representations. With matching, phrases may be matched to other phrases typically used with the associated industry (e.g. in the airline industry, “second class” closely matches “economy class”). Also, advanced models, e.g. a hidden Markov model, may be used. Automatic speech recognition component 209 consequently generates a text representation of the speech content using phonemic symbols associated with the first language (which the user is articulating).

While automatic speech recognition component 209 may support the exemplary list of language translation options as previously discussed, the embodiment may further support regional differences of a specific language. For example, the English language may differentiated by English—United Kingdom, English—United States, English—Australia/New Zealand, and English—Canada. The embodiment of the invention may further different smaller regions within larger regions. For example, English—United States may be further differentiated as English—United States, New York City, English—United States, Boston, English—United States, Dallas, and so forth. English—United Kingdom may be differentiated as English—United Kingdom, London, English—United Kingdom, Birmingham, and so forth. Consequently, automatic speech recognition component 209 may support the regional accent of the speaker. Moreover, automatic speech recognition component 209 may identify colloquialisms that are used in the region and replace the colloquialisms with standardized expression of the language. (A colloquialism is an expression that is characteristic of spoken or written communication that seeks to imitate informal speech.) A colloquialism may present difficulties in translating from one language to another language. For example, a colloquialism may correspond to nonsense or even an insult when translated into another language.

Text-to-speech synthesis component 211 supports prosody. (Prosody is associated with the intonation, rhythm, and lexical stress in speech. Additionally, different accents (e.g., English with a British accent or English with an American accent) may be specified. The prosodic features of a unit of speech, whether a syllable, word, phrase, or clause, are called suprasegmental features because they affect all the segments of the unit. These features are manifested, among other things, as syllable length, tone, and stress. The converted text is then synthesized to phonetic and prosodic symbols to form a digital audio stream. Text to speech synthesis component 211 inserts prosodic symbols into the text represented that was generated by automatic speech recognition component 209. The prosodic symbols may further represent the pitch and emotional aspects of the speech being articulated by the user.

Speech translation component 213 performs speech conversion from language to another language with the grammar/vocabulary intact. Speech translation component 213 processes the converted text from text to speech synthesis component 211 to obtain the translated speech signal that is heard by the user.

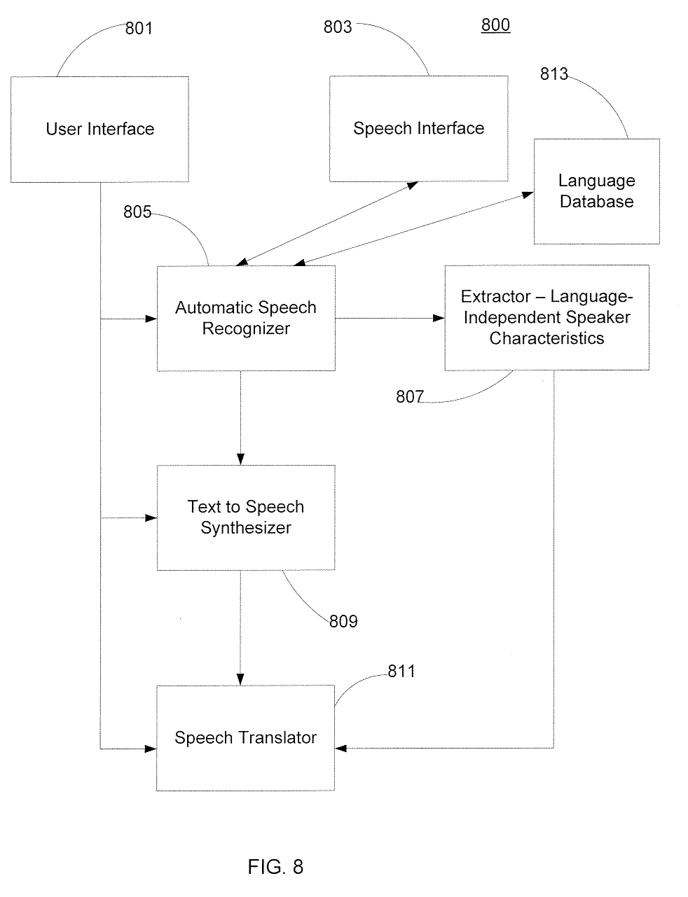

As will be further discussed with an exemplary architecture shown in FIG. 8, apparatus 200 may determine a language-independent speaker parameter that depends on the speaker but is independent of an associated language. Exemplary parameters include the gender, age, and health of the speaker and are invariant of the language. Apparatus 200 may process a received speech in order to extract language-independent speaker parameters (e.g., extractor 807 as shown in FIG. 8). Alternatively, language-independent speaker parameters may be entered through a user interface (e.g., user interface 801 as shown in FIG. 8).

With the architecture shown in FIG. 2, there is minimal latency with ATS server 207 on the BSS side. ATS server 207 can be plugged-in on the access side of the network without substantially affecting the existing network setup and traffic. Any hardware or software upgrades of ATS server 207 can be independent of the existing network setup. The architecture that is shown in FIG. 2 can be extended to code division multiple access (CDMA) as well as Universal Mobile Telecommunications System (UMTS) for any 2G or 3G network call setup. As will be later discussed, the above translation service can be extended to a call center which interfaces to a telephony network.

With an embodiment of the invention, if ATS server 207 detects that the received speech signal does not have content in the first language, ATS server 207 is transparent to the received speech signal. Non-speech content (e.g., music) or speech content in a language other than the first language is passed without modification.

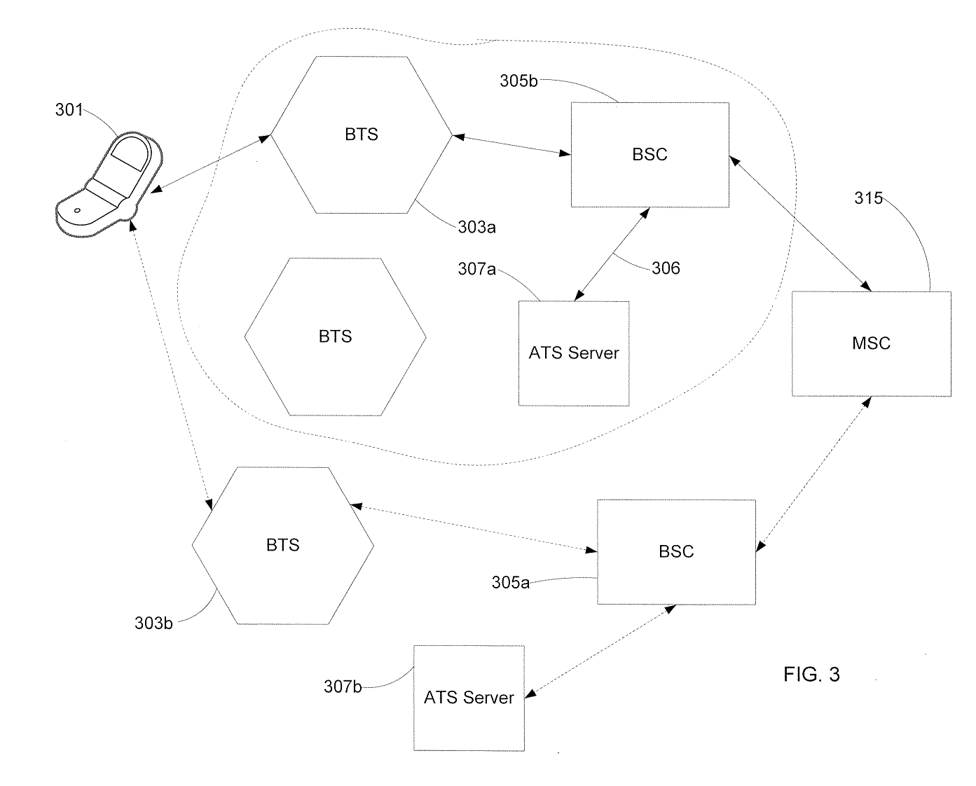

FIG. 3 shows a wireless system supporting a multi-lingual telephonic service during a handover in accordance with an embodiment of the invention. In the scenario depicted in FIG. 3, the wireless system determines that a handover for wireless device 301 is required in order to maintain a desired quality of service. Before the handover, wireless device 301 communicates with BTS 303a, which is connected to MSC 315 through BSC 305a and is supported by ATS server 307a through link 306. Link 306 supports both a voice path (either bidirectional or unidirectional) and messaging between BSC 305b and ATS 307b. After the handover, wireless device 301 communicates with BTS 303b, which is connected to MSC 315 through BSC 305b and is supported by ATS server 307b. (However, one should note that a handover may not result in the ATS server changing if the same ATS server is configured with the BTS's associated with the call before and after the handover.) Since the call is supported by a different BTS, BSC, and ATS server after the handover, the user may notice some disruption in the translation service if a portion of speech is not processed during the time duration. However, embodiments of the invention support the synchronization of ATS servers so that the disruption of speech translation is reduced by a handover.

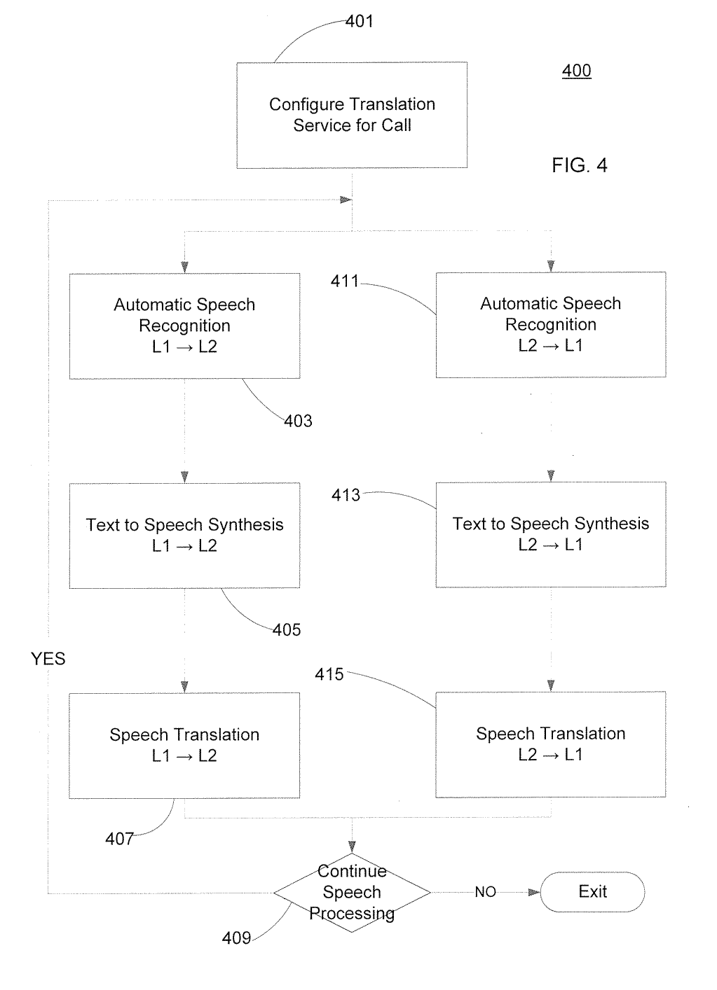

FIG. 4 shows flow diagram 400 for a multi-lingual telephonic service during a handover in accordance with an embodiment of the invention. Some or all steps of flow diagram 400 may be executed by ATS server 207 as shown in FIG. 2. While flow diagram 400 shows bidirectional operation (translation in both conversational directions), the embodiment of the invention may support unidirectional operation (translation only in one direction). In step 401, a user configures the translation service for translating from a first language to a second language for the uplink path (wireless device to BTS). In the embodiment, the translation service is symmetric so that speech is translated from the second language to the first language for the downlink path (BTS to wireless device). Additional configuration parameters may be supported to preserve the user's voice qualities so that the user can be recognized from the translated speech.

In step 403, automatic speech recognition component 209 performs speech recognition from the first language to the second language. In step 405, text to speech synthesis component 211 incorporates intonation, rhythm, and lexical stress that are associated with the second language. In step 407, speech translation component 407 performs speech conversion from language to another language with the grammar/vocabulary intact. Steps 411, 413, and 415 correspond to steps 403, 405, and 407, respectively, but in the other direction. In step 409, process 400 determines whether to continue speech processing (i.e., whether the call continues with detected speech).

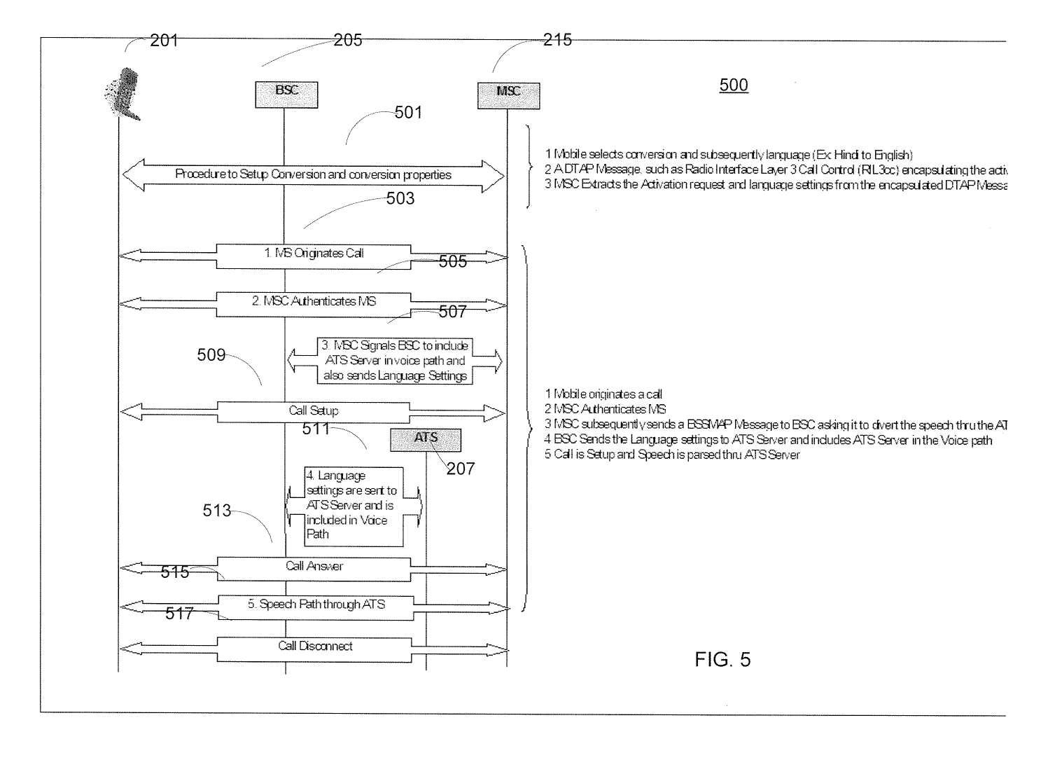

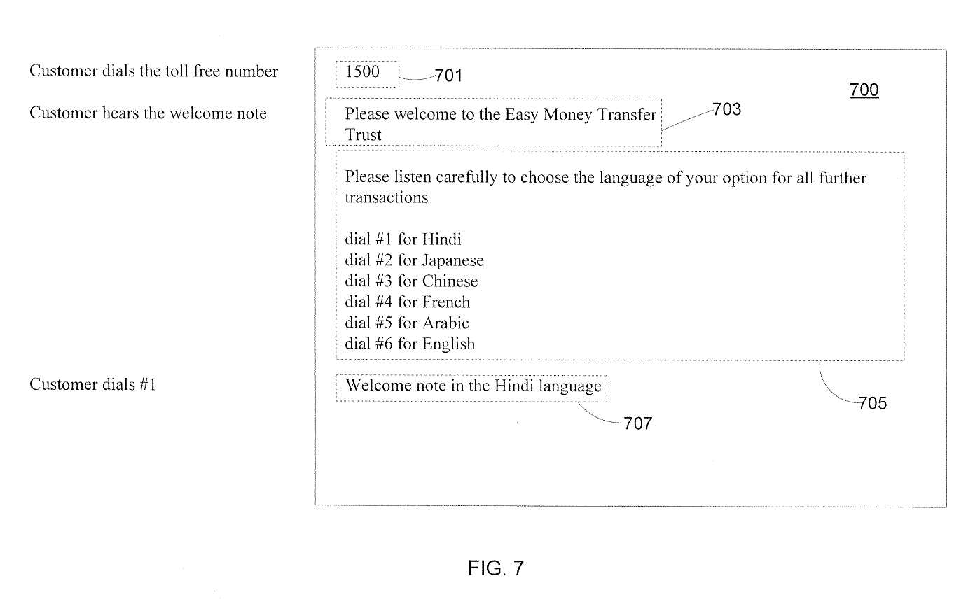

FIG. 5 shows messaging scenario 500 between entities wireless device 201, MSC 215 (through BTS 203 and BSC 205) in accordance with an embodiment of the invention. A user of wireless device 201 requests a call with translation service by entering configuration data through a user interface (e.g., as shown in FIG. 7). Consequently, wireless device initiates procedure 501 to establish translation properties for the call. As part of procedure 501, a DTAP message, e.g., Radio Interface Layer 3 Call Control (RL3 cc) encapsulating the activation, is sent to MSC 215. MSC 215 extracts the activation request and language settings from the encapsulated DTAP message.

Wireless device 201 then originates the call with call 503, and MSC 215 authenticates wireless device 201 with call 505. With message 507, MSC 215 signals BSC 205 to include ATS server 207 in the voice path (which may be bidirectional or unidirectional) and sends ATS server 207 translation configuration data through BSC 205. The call is initiated by message 509. Language settings are sent to ATS server 207 from BSC 205 in message 511. The call is answered by the other party, as indicated by message 513. A voice path is subsequently established from BTS 303a (as shown in FIG. 3) through BSC 205 to ATS server 207 so that speech can be diverted to ATS server 207 by message 515. Speech is translated during the call until the occurrence of message 517, which indicates that the call has been disconnected.

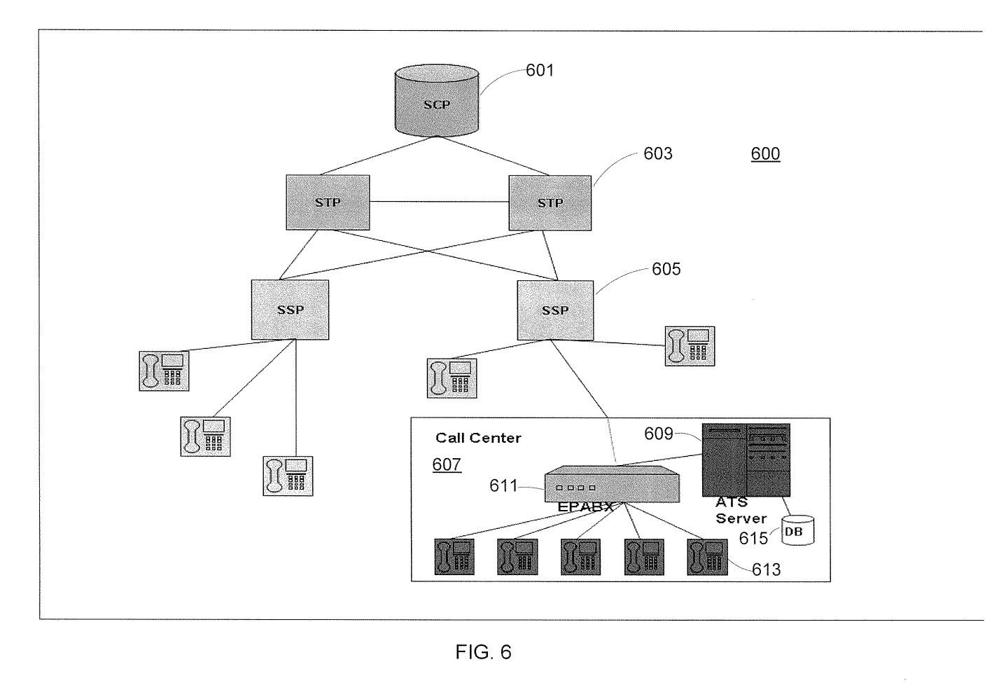

FIG. 6 shows an architecture of an inbound call center 607 with telephonic network 600. Inbound call centers, e.g., call center 607, provides services for customers calling for information or reporting problems. An advantage offered by inbound call center 607 is that a call enter executive need not know the native language of a calling customer. Call center 607 supports a multi-lingual telephonic service in accordance with an embodiment of the invention. As an example, call center 600 may support a telemarketing center with internal telephonic devices (e.g., telephonic device 613) to perspective customers (associated with external telephonic devices not shown in FIG. 6). SCP (Service Control Point) 601 comprises a remote database within the System Signaling 7 (SS7) network. SCP 601 provides the translation and routing data needed to deliver advanced network services. SSP (Service Switching Point) 605 comprises a telephonic switch that can recognize, route, and connect intelligent network (IN) calls under the direction of SCP 601. STP (Service Transfer Point) 603 comprises a packet switch that shuttles messages between SSP 605 and SCP 601. EPABX (Electronic Private Automatic Branch exchange) 611 supports telephone calls between internal telephonic devices and external telephonic devices.

With an embodiment of the invention, a user may select the language that the user is speaking. However, embodiments of the invention may support automatic language identification from the user's dialog. Identification of a spoken language may consist of the following steps:
1. Develop a phonemic/phonetic recognizer for each language
   a. This step consists of acoustic modeling phase and language modeling phase
   b. Trained acoustic models of phones in each language are used to estimate a stochastic grammar for each language. These models can be trained using either HMMs or neural networks
   c. The likelihood scores for the phones resulting from the above steps incorporate both acoustic and phonotactic information
2. Combine the acoustic likelihood scores from the recognizers to determine the highest scoring language
   a. The scores obtained from step 1 are then later accumulated to determine the language with the largest likelihood

ATS server 609 translates a received speech signal from a first language to a second language by executing flow diagram 400 and using data (e.g., as mappings between sounds and phonemes, grammatical rules, and mappings between colloquialisms and standardized language) from database 615. An exemplary architecture of ATS server 609 will be discussed with FIG. 8. For example, a user of telephonic device 613 may configure ATS server 609 to translate speech during a call to an external telephonic device.

With an exemplary embodiment of the invention of inbound call center 607, customer-support executives receive calls from customers requesting information or reporting a malfunction. A customer from the same or another end office (EO) calls call center 607 by dialing a toll free number. The customer is prompted for options on the telephone in order to choose the customer's desired language as exemplified by the following scenario:

| | |
|---|---|
| Customer dials the toll free number | 1500 |
| Customer hears the brief welcome note | Welcome to the |
| | Easy Money Transfer Union |
| | dial #1 for English |
| | Hindi bhashaa key liye dho |
| | dial Karen (dial #2 for Hindi) |
| Customer dials #2 | Welcome note in the Hindi |
| | language |
| Customer starts speaking in Hindi | Mein Mayur Baat Kar Rahaa |
| | hoon . . . |
| Customer support executive listens as | This is Mayur speaking here . . . |
| Customer support executive says | Please hold the |
| | line for a moment |
| | while I check your balance |
| Customer listens as | kripaya kuch der pritiksha |
| | kijiye aapka bahi khata |
| | vislechan mein hai |

Based on the customer's chosen language (assume that the customer selects the option #1—Hindi), PBX 611 routes the call through ATS server 609 which receives Hindi speech as input and converts it into English for the customer-support executive. Moreover, the customer hears subsequent dialog from the customer-support executive in Hindi.

While a country is typically associated with a single language, a country may have different areas in which different languages are predominantly spoken. For example, India is divided into many states. The language spoken in one state is often different from the languages spoken in the other states. The capabilities of call center 607, as described above, are applicable when a customer-support executive gets posted from one state to another.

FIG. 7 shows exemplary display 700 for configuring a translation service in accordance with an embodiment of the invention. In display area 701, the user of wireless device 301 dials a toll free telephone number. Once the tool free number is established, a welcome message is displayed in display area 703. The user selects a language for subsequent transactions in display region 705. With exemplary display 700, the selected language corresponds to the source language. Speech is translated from the source language into English.)

FIG. 8 shows an architecture of Automatic Speech Recognition/Text to Speech Synthesis/Speech Translation (ATS) server 800 in accordance with an embodiment of the invention. ATS server 800 interacts with BSC 205 through link 306 (as shown in FIG. 3) via communications interface 803 in order to establish a voice path to automatic speech recognizer 805. Translation configuration data is provided from user interface 801. While user interface 801 and communications interface 803 is shown separately, interfaces 801 and 803 are typically incorporated in the same physical component, in which messaging is logically separated from speech data. Both messaging and speech data are typically conveyed over link 306.

As previously discussed, automatic speech recognizer 805 matches sounds of the first language to phonetic representations to form a text representation of the speech signal (which has content in the first language). Automatic speech recognizer 805 accesses language specific data, e.g., sound-phonetic mappings, grammatical rules, and colloquialism-standardized language expression mappings, from database 813. Extractor 807 extracts language-independent speaker parameters from the received speech signal. The language-independent parameters are provided to speech translator 811 in order to preserve language-independent speaker characteristics during the translation process to the second language.

Text-to-speech synthesizer 809 inserts prosodic symbols into the text representation from automatic speech recognizer 805 and forms a digital audio stream. Speech translator 811 consequently forms a translated speech from the digital audio stream.

As can be appreciated by one skilled in the art, a computer system (e.g., computer 100 as shown in FIG. 1) with an associated computer-readable medium containing instructions for controlling the computer system may be utilized to implement the exemplary embodiments that are disclosed herein. The computer system may include at least one computer such as a microprocessor, a cluster of microprocessors, a mainframe, and networked workstations.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

I claim:

1. A method for translating speech during a wireless communications session, comprising:
(a) receiving a received uplink speech signal from a wireless device, the received uplink speech signal being transported over a uplink wireless channel, the wireless device being served by a serving base transmitter station;
(b) translating the received uplink speech from a first language to a second language to form a translated uplink speech signal; and
(c) sending the translated uplink speech signal to a telephonic device.

2. The method of claim 1, further comprising:
(d) receiving a received downlink speech signal from the telephonic device;
(e) translating the received downlink speech signal from the second language to the first language to form a translated downlink speech signal; and
(f) sending the translated downlink speech to the wireless device over a downlink wireless channel.

3. The method of claim 1, wherein (b) comprises:
(b)(i) recognizing a first language speech content in the received uplink speech signal, the first language speech content corresponding to the first language;
(b)(ii) in response to (b)(i), forming a first converted text representation of the first language speech content;
(b)(iii) converting the first converted text representation to a first synthesized symbolic representation; and
(b)(iv) forming the translated uplink speech signal from the first synthesized symbolic representation.

4. The method of claim 2, wherein (e) comprises:
(e)(i) recognizing a second language speech content in the received downlink speech signal, the second language speech content corresponding to the second language;
(e)(ii) in response to (e)(i), forming a second converted text representation of the second language speech content;
(e)(iii) converting the second converted text representation to a second synthesized symbolic representation; and
(e)(iv) forming the translated downlink speech signal from the second synthesized symbolic representation.

5. The method of claim 3, wherein (b) further comprises:
(b)(v) obtaining a configuration parameter for a user of the wireless device; and
(b)(vi) modifying the translated uplink speech signal in accordance with the configuration parameter.

6. The method of claim 1, further comprising:
(d) obtaining a translation configuration request to provide a translation service for translating the received uplink speech signal from the first language to the second language.

7. The method of claim 2, further comprising:
(d) obtaining a translation configuration request to provide a translation service for translating the received downlink speech signal from the second language to the first language.

8. The method of claim 1, further comprising:
(d) supporting a handover of the wireless device, wherein the wireless device communicates with a first base transceiver station before the handover and with a second base transceiver station after the handover.

9. The method of claim 8, wherein the wireless device is served by a first Automatic Speech Recognition/Text to Speech Synthesis/Speech Translation (ATS) server before the handover and by a second ATS server after the handover.

10. The method of claim 3, wherein the first language speech content is formatted as phonemes.

11. The method of claim 1, wherein (b) comprises:
(b)(i) identifying a speaker parameter that is associated with the received uplink speech, the speaker parameter being independent of an associated language; and
(b)(ii) preserving the speaker parameter when forming the translated uplink speech signal.

12. The method of claim 11, wherein (b)(i) comprises:
(b)(i)(1) obtaining the speaker parameter from a user interface.

13. The method of claim 11, wherein (b)(i) comprises:
(b)(i)(1) processing the received uplink speech signal to extract the speaker parameter.

14. The method of claim 6, wherein (d) comprises:
(d)(i) obtaining a regional identification of the source of the received uplink speech; and
wherein (b) comprises:
(b)(i) identifying a colloquialism that is associated with the first language of the received uplink speech; and
(b)(ii) replacing the colloquialism with a standardized phrase of the first language when forming the translated uplink speech signal.

15. The method of claim 3, wherein (b)(iii) comprises:
(b)(iii)(1) inserting at least one prosodic symbol within the first synthesized symbolic representation.

16. The method of claim 1, further comprising:
(d) detecting content in the received uplink speech signal that does not correspond to the first language; and
(e) in response (d), disabling (b).

17. An apparatus for translating a speech signal during a communications session between a first person and a second person, comprising:
a speech recognizer configured to perform the steps comprising:
obtaining translation configuration data that specifies a first language and a second language;
receiving a first received speech signal from a communications interface; and
converting the first speech signal to a first symbolic representation, the first symbolic representation containing a first plurality of phonetic symbols, each phonetic symbol representing a sound associated with the first language;
a parameter extractor configured to perform the steps comprising:
determining at least one speaker parameter that is independent of an associated language;
a text-to-speech synthesizer configured to perform the steps comprising:
inserting a first plurality of prosodic symbols within the first symbolic representation; and
synthesizing a first digital audio stream from the first symbolic representation; and
a speech translator configured to perform the steps comprising:
translating the first digital audio stream to the second language; and
generating a first translated speech signal in the second language.

18. The apparatus of claim 17, wherein:
the speech recognizer further configured to perform the steps comprising:
receiving a second received speech signal from a second device; and
converting the second speech signal to a second symbolic representation, the second symbolic representation containing a second plurality of phonetic symbols associated with the second language;
the text-to-speech synthesizer further configured to perform the steps comprising:
inserting a second plurality of prosodic symbols within the second symbolic representation; and
synthesizing a second digital audio stream from the second symbolic representation; and
the speech translator further configured to perform the steps comprising:
translating the second digital audio stream to the first language; and
generating a second translated speech signal in the first language.

19. The apparatus of claim 17, wherein:
the speech recognizer for further configured to perform the steps comprising:
obtaining a regional identification of the source of the first received speech signal;
identifying a colloquialism that is associated with the first language of the first received speech signal; and
replacing the colloquialism with a standardized phrase of the first language in the first symbolic representation.

20. A method for translating speech during a communications session, comprising:
(a) receiving a received speech signal from a communications device;
(b) translating the received speech from a first language to a second language to form a translated speech signal by:
(b)(i) recognizing a first language speech content in the received speech signal, the first language speech content corresponding to the first language;
(b)(ii) in response to (b)(i), forming a converted text representation of the first language speech content having a plurality of phonetic symbols;
(b)(iii) converting the converted text representation to a synthesized symbolic representation, the synthesized symbolic having the plurality of phonetic symbols and a plurality of prosodic symbols;
(b)(iv) forming the translated speech signal from the synthesized symbolic representation;
(b)(v) identifying a speaker parameter that is associated with the received speech signal, the speaker parameter being independent of the first language and the second language; and
(b)(vi) preserving the speaker parameter when forming the translated speech signal; and
(c) sending the translated speech signal to another communications device.
